(19) United States
(12) Patent Application Publication
(10) Pub. No.: US 2025/0375704 A1
(43) Pub. Date: Dec. 11, 2025

(54) SYSTEM, METHOD, AND PROGRAM FOR OUTPUTTING GAME MEDIUM SET

(71) Applicant: CYGAMES, INC., Tokyo (JP)

(72) Inventor: Shuichi Kurabayashi, Tokyo (JP)

(73) Assignee: CYGAMES, INC., Tokyo (JP)

(21) Appl. No.: 19/310,310

(22) Filed: Aug. 26, 2025

Related U.S. Application Data
(63) Continuation of application No. PCT/JP2024/013931, filed on Apr. 4, 2024.

(30) Foreign Application Priority Data
Apr. 4, 2023 (JP) 2023-060931

(51) Int. Cl. A63F 13/52

(52) U.S. Cl. CPC A63F 13/52

(57) ABSTRACT

One or more embodiments of the invention is a system that outputs a game medium set to be presented to a player in a game in which game medium sets each constituted of a plurality of game media are used, wherein the system: generates candidate game medium sets for clearing one unit game by replacing, with other game media, some game media in game medium sets with which the one unit game has been cleared, the game medium sets being included in game logs; and executes game plays of the one unit game by using the candidate game medium sets for clearing the one unit game and outputs a game medium set with which the one unit game has been cleared.

### TECHNICAL FIELD

The present invention relates to systems, methods, and programs for outputting a game medium set. In particular, the present invention relates to a system, a method, and a program for outputting a game medium set to be presented to a player in a game in which game medium sets constituted of a plurality of game media are used.

### BACKGROUND ART

The popularization of information processing apparatuses having communication functions, such as recent smartphones, has rapidly advanced, and a large number of games that are executed on such information processing apparatuses having communication functions have been released. Among games of this type, there is a widely known type of game in which a single user (player) accomplishes a game mission by using a game medium set including a plurality of game media (characters, items such as cards or equipment, or the like). For example, Patent Literature 1 discloses a system in which record information is accumulated each time other users accomplish game missions, and when a user determines a group of objects for challenging a game mission, object group information that serves as a guide for accomplishing the game mission is presented to the user on the basis of the accumulated record information.

### CITATION LIST

### Patent Literature

### PTL 1

Publication of Japanese Patent No. 6345866

### SUMMARY OF INVENTION

### Technical Problem

In a game in which a single player configures a plurality of game media to play the game, determining how to configure his or her own game medium set is a factor lying at the core of the essence of the game. Systems that propose media or combinations of media in a service have hitherto been called information recommendation systems and utilized in the field of e-commerce. For example, in online sales services, information recommendation functions for recommending items to users have been serving as the core of the services. With existing information recommendation systems, the accuracy of recommendation has been improved by considering decision making by users as an unobservable factor, i.e., as a black box, observing the probabilities of resulting in page views (click rates), the probabilities of resulting in purchases (conversion rates), or the like, and thereby running a feedback loop for gradually improving a recommendation model. However, such existing recommendation systems or methods in which clearing histories of other users are more simply recommended have been suffering from the occurrence of the problem in which recommendations with low accuracies are presented to a certain number of players (cold start problem), as well as the occurrence of the “exposure bias” problem, in which an excessive feedback loop occurs as a result of intermediate and advanced players adopting recommended configurations, making a very small number of party configurations “established tactics”.

The present invention, in one aspect thereof, has been made in order to solve such problems, and it is an object thereof to provide a system that is capable of outputting a game medium set to be presented to a player.

### Solution to Problem

[1] A system in one embodiment of the present invention is as follows.

A system that outputs a game medium set to be presented to a player in a game in which game medium sets each constituted of a plurality of game media are used, wherein the system:
generates candidate game medium sets for clearing one unit game by replacing, with other game media, some game media in game medium sets with which the one unit game has been cleared, the game medium sets being included in game logs; and
executes game plays of the one unit game by using the candidate game medium sets for clearing the one unit game and outputs a game medium set with which the one unit game has been cleared.

[2] One embodiment of the present invention is as follows.

A system according to [1], wherein outputting game medium sets with which the one unit game has been cleared includes:
executing the game by using a player terminal or a virtual instance generated for virtualizing a software environment of a player terminal, executing game plays of the one unit game by using the candidate game medium sets for clearing the one unit game, and outputting a game medium set with which the one unit game has been cleared.

[3] One embodiment of the present invention is as follows.

A system according to [1] or [2], wherein outputting game medium sets with which the one unit game has been cleared includes:
storing candidate game medium sets with which the one unit game has been cleared as cleared game medium sets of the one unit game; and
outputting at least one game medium set among the cleared game medium sets of the one unit game.

[4] One embodiment of the present invention is as follows.

A system according to [3], wherein outputting at least one game medium set among the cleared game medium sets of the one unit game includes outputting at least one game medium set among a plurality of stored cleared game medium sets of the one unit game on the basis of game media possessed by the player.

[5] One embodiment of the present invention is as follows.

A system according to any one of [1] to [4], wherein generating candidate game medium sets includes generating candidate game medium sets by individually replacing one or more game media having high in-game values, the game media constituting parts of game medium sets with which one unit game has been cleared, the game medium sets being included in game logs, with one or more game media having high preset priority levels or priority ranks.

[6] One embodiment of the present invention is as follows.

A system according to any one of [1] to [4], wherein generating candidate game medium sets includes generating candidate game medium sets by individually replacing one or more game media having high in-game values with one or more other game media, the game media constituting parts of game medium sets with which one unit game has been cleared, the game medium sets being included in game logs, and the one or more other game media are game media having high preset priority levels or priority ranks and having high compatibility individually with the one or more game media that are replaced.

[7] One embodiment of the present invention is as follows.

A system according to [5] or [6], wherein the one or more game media having high in-game values, the game media constituting parts of game medium sets with which one unit game has been cleared, the game medium sets being included in game logs, are game media having high rarities or game media having low rates of possession by players among the game medium sets.

[8] One embodiment of the present invention is as follows.

A system according to any one of [1] to [7], wherein generating candidate game medium sets includes acquiring, for each subject unit game, game medium sets with which the unit game has been cleared from a game server storing game logs generated through actual game plays by players.

[9] One embodiment of the present invention is as follows.

A system according to any one of [1] to [8], wherein:
each game medium has a level set therefor; and
when game plays of one unit game are executed by using candidate game medium sets for clearing the one unit game, the individual game media included in the candidate game medium sets are set to a preset level corresponding to the one unit game.

[10] One embodiment of the present invention is as follows.

A system according to any one of [1] to [9], wherein when the game is executed by using a virtual instance, the game is executed in the virtual instance in a headless mode or with a GPU and a sound device virtualized so that at least graphic processing and sound processing are substantially disabled.

[11] One embodiment of the present invention is as follows.

A system according to any one of [1] to [10], wherein generating candidate game medium sets is generating candidate game medium sets for clearing one unit game by replacing, with other game media, some game media in game medium sets with which the one unit game has been cleared with a certain grade or higher or while satisfying a condition, the game medium sets being included in game logs.

[12] A method in one embodiment of the present invention is as follows.

A method of outputting a game medium set to be presented to a player in a game in which game medium sets each constituted of a plurality of game media are used, wherein:
candidate game medium sets for clearing one unit game are generated by replacing, with other game media, some game media in game medium sets with which the one unit game has been cleared, the game medium sets being included in game logs; and
game plays of the one unit game are executed by using the candidate game medium sets for clearing the one unit game, and a game medium set with which the one unit game has been cleared is output.

[13] One embodiment of the present invention is as follows.

A method according to [12], wherein outputting game medium sets with which the one unit game has been cleared includes:
executing the game by using a player terminal or a virtual instance generated for virtualizing a software environment of a player terminal, executing game plays of the one unit game by using the candidate game medium sets for clearing the one unit game, and outputting a game medium set with which the one unit game has been cleared.

[14] One embodiment of the present invention is as follows.

A method according to [12] or [13], wherein generating candidate game medium sets includes generating candidate game medium sets by individually replacing one or more game media having high in-game values, the game media constituting parts of game medium sets with which one unit game has been cleared, the game medium sets being included in game logs, with one or more game media having high preset priority levels or priority ranks.

[15] One embodiment of the present invention is as follows.

A method according to [12] or [13], wherein generating candidate game medium sets includes generating candidate game medium sets by individually replacing one or more game media having high in-game values with one or more other game media, the game media constituting parts of game medium sets with which one unit game has been cleared, the game medium sets being included in game logs, and the one or more other game media are game media having high preset priority levels or priority ranks and having high compatibility individually with the one or more game media that are replaced.

[16] A program in one embodiment of the present invention is as follows.

A program for causing a computer to execute a method according to any one of [12] to [15].

### Advantageous Effects of Invention

The present invention, in one aspect thereof, makes it possible to output a game medium set to be presented to a player.

### BRIEF DESCRIPTION OF DRAWINGS

FIG. 1 is an overall configuration diagram of a system in one embodiment of the present invention.

FIG. 2 is a block diagram showing the hardware configuration of a recommendation apparatus in one embodiment of the present invention.

FIG. 3 is a block diagram showing the hardware configuration of a virtual instance server in one embodiment of the present invention.

FIG. 4 is a block diagram showing the hardware configuration of a test game server in one embodiment of the present invention.

FIG. 5 is a block diagram showing the hardware configuration of a game server in one embodiment of the present invention.

FIG. 6 is an example functional block diagram of the system in one embodiment of the present invention.

FIG. 7 is a figure for explaining an example flowchart of processing by the system in one embodiment of the present invention.

### DESCRIPTION OF EMBODIMENTS

A system in an embodiment of the present invention will be described below with reference to the drawings. A system 1 in the embodiment of the present invention is a system that can present recommendation information such as a recommended party to a player (user) in a game that proceeds as quests are cleared by using a party constituted of a plurality of characters (party configuration). Characters are one example of game media, and other game media such as cards or equipment items may be used. A party is one example of a game medium set (game medium group) constituted of a plurality of game media. For example, a game medium set may be a configured deck or a combination of cards or equipment items. For convenience of description, the game in the embodiment of the present invention will be referred to as a “game G”. The game G is an online game that can be played on a mobile terminal such as a smartphone. In the embodiment of the present invention, an app may mean an app installed in a smartphone or a tablet, or apps may mean applications in general. In the embodiment of the present invention, IDs are one example of identification information that enables unique identification. For example, player IDs are one example of player identification information that enables unique identification of players. The configuration of the embodiment described below, as well as the operations and advantages resulting from the configuration, are merely one example, and there is no limitation to the content described below. As will be described later, embodiments of the present invention are not limited to a system and may be a method, a program, or the like.

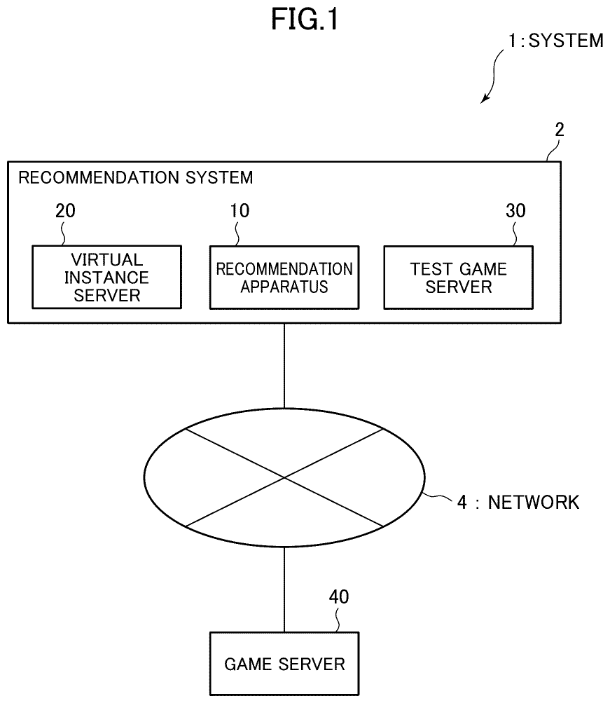

FIG. 1 is an overall configuration diagram of the system 1 in the embodiment of the present invention. As shown in FIG. 1, the system 1 includes a recommendation system 2 and a game server 40. The recommendation system 2 and the game server 40 are connected to a network 4 such as the Internet and are able to communicate with each other.

The recommendation system 2 includes a recommendation apparatus 10, a virtual instance server 20, and a test game server 30. In the description of the hardware configuration in the embodiment of the present invention, it is assumed for convenience that each of the recommendation apparatus 10, the virtual instance server 20, and the test game server 30 is realized by using a single apparatus. However, there is no limitation to this configuration. In one example, the recommendation apparatus 10 can be constituted of one or more apparatuses, the virtual instance server 20 can be constituted of one or more apparatuses, and the test game server 30 can be constituted of one or more apparatuses. In one example, the recommendation system 2 can be realized by using a single apparatus (may be a single apparatus). In one example, the recommendation apparatus 10, the virtual instance server 20, and the test game server 30 can be realized by using a virtual environment such as a virtual server. In this case, the recommendation system 2 can be realized by using a virtual environment in which virtualization of all the constituent elements is realized. As technology for the virtual environment, for example, it is possible to employ the technology disclosed in Japanese Unexamined Patent Application, Publication No. 2021-145939.

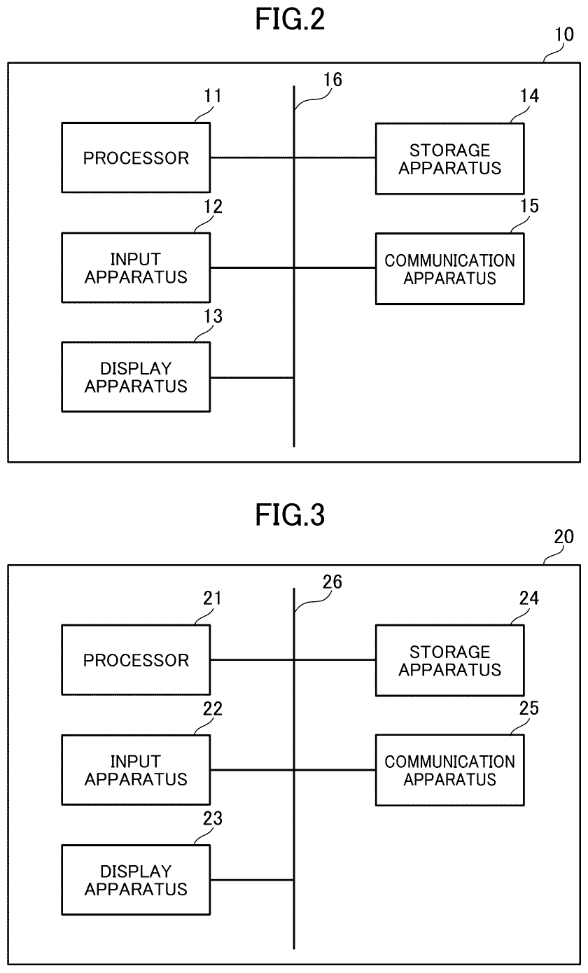

FIG. 2 is a block diagram showing the hardware configuration of the recommendation apparatus 10 in one embodiment of the present invention. The recommendation apparatus 10 includes a processor 11, an input apparatus 12, a display apparatus 13, a storage apparatus 14, and a communication apparatus 15. These individual constituent apparatuses are connected via a bus 16. It is assumed that interfaces are interposed as needed between the bus 16 and the individual constituent apparatuses.

The processor 11 controls the overall operation of the recommendation apparatus 10. For example, the processor 11 is a CPU. The processor 11 executes various kinds of processing by loading programs and data stored in the storage apparatus 14 and executing the programs. The processor 11 may be constituted of a plurality of processors.

The input apparatus 12 is a user interface for accepting inputs from a user to the recommendation apparatus 10, such as a touch panel, a touch pad, a keyboard, a mouse, or buttons. The display apparatus 13 is a display that displays application screens, etc. to the user of the recommendation apparatus 10 under the control of the processor 11.

The storage apparatus 14 includes a main storage apparatus and an auxiliary storage apparatus. The main storage apparatus is, for example, a volatile memory that allows high-speed reading and writing of information and is used as a storage area and a work area when the processor 11 processes information. The auxiliary storage apparatus stores various programs, as well as data used by the processor 11 when the individual programs are executed. The auxiliary storage apparatus is a non-volatile storage or a non-volatile memory, for example, a flash memory such as an eMMC, a UFS, or an SSD, and may be of the removable type.

The communication apparatus 15 is a module, a device, or an apparatus that is capable of sending data to and receiving data from other computers such as user terminals (player terminals) or servers via a network. The communication apparatus 15 may be a device, a module, or the like for wireless communication or a device, a module, or the like for wired communication. Note that in the case where inputs/outputs by the user of the recommendation apparatus 10 are only inputs/outputs via the communication apparatus 15, the recommendation apparatus 10 need not include the input apparatus 12 and the display apparatus 13.

FIG. 3 is a block diagram showing the hardware configuration of the virtual instance server 20 in one embodiment of the present invention. The virtual instance server 20 includes a processor 21, an input apparatus 22, a display apparatus 23, a storage apparatus 24, and a communication apparatus 25. These individual constituent apparatuses are connected via a bus 26. It is assumed that interfaces are interposed as needed between the bus 26 and the individual constituent apparatuses. The individual elements, namely, the processor 21, the input apparatus 22, the display apparatus 23, the storage apparatus 24, and the communication apparatus 25, respectively correspond to the processor 11, the input apparatus 12, the display apparatus 13, the storage apparatus 14, and the communication apparatus 15 described earlier and have similar configurations, and thus descriptions thereof will be omitted. Note that in the case where inputs/outputs by a user of the virtual instance server 20 are only inputs/outputs via the communication apparatus 25, the virtual instance server 20 need not include the input apparatus 22 and the display apparatus 23.

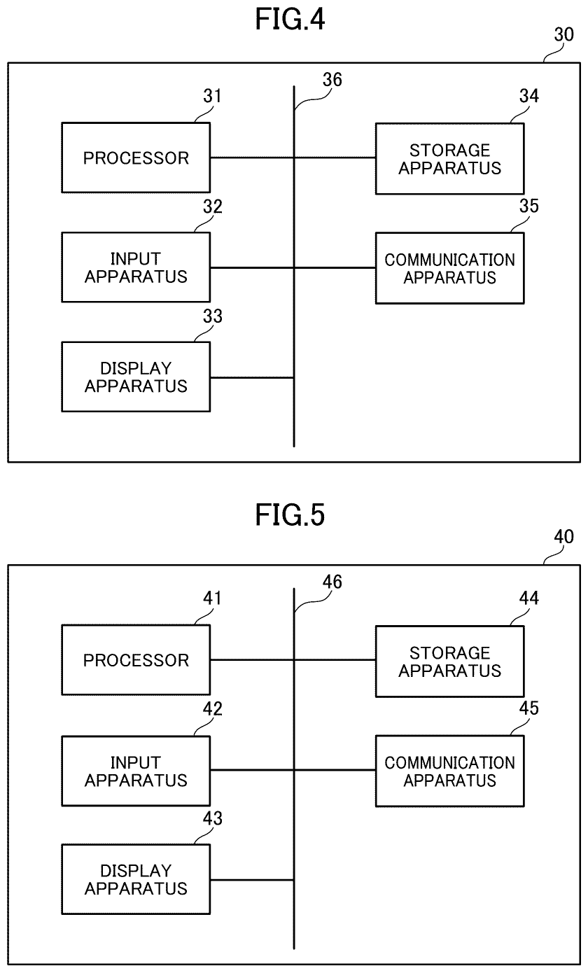

FIG. 4 is a block diagram showing the hardware configuration of the test game server 30 in one embodiment of the present invention. The test game server 30 includes a processor 31, an input apparatus 32, a display apparatus 33, a storage apparatus 34, and a communication apparatus 35. These individual constituent apparatuses are connected via a bus 36. It is assumed that interfaces are interposed as needed between the bus 36 and the individual constituent apparatuses. The individual elements, namely, the processor 31, the input apparatus 32, the display apparatus 33, the storage apparatus 34, and the communication apparatus 35, respectively correspond to the processor 11, the input apparatus 12, the display apparatus 13, the storage apparatus 14, and the communication apparatus 15 described earlier and have similar configurations, and thus descriptions thereof will be omitted. Note that in the case where inputs/outputs by a user of the test game server 30 are only inputs/outputs via the communication apparatus 35, the test game server 30 need not include the input apparatus 32 and the display apparatus 33.

The game server 40 has a configuration similar to that of an ordinary game server that provides an online game. In the description of the hardware configuration of the embodiment of the present invention, it is assumed for convenience that the game server 40 is realized by using a single apparatus. However, there is no limitation to this configuration. The game server 40 may be realized by using one or more apparatuses or may be realized by using a virtual environment. The test game server 30 may have the same configuration as the game server 40 but differs from the game server 40 in that the test game server 30 is not accessed by player terminals of ordinary users (ordinary players) and in that the test game server 30 accepts only accesses from the virtual instance server 20.

FIG. 5 is a block diagram showing the hardware configuration of the game server 40 in one embodiment of the present invention. The game server 40 includes a processor 41, an input apparatus 42, a display apparatus 43, a storage apparatus 44, and a communication apparatus 45. These individual constituent apparatuses are connected via a bus 46. It is assumed that interfaces are interposed as needed between the bus 46 and the individual constituent apparatuses. The individual elements, namely, the processor 41, the input apparatus 42, the display apparatus 43, the storage apparatus 44, and the communication apparatus 45, respectively correspond to the processor 11, the input apparatus 12, the display apparatus 13, the storage apparatus 14, and the communication apparatus 15 described earlier and have similar configurations, and thus descriptions thereof will be omitted. Note that in the case where inputs/outputs by a user of the game server 40 are only inputs/outputs via the communication apparatus 45, the game server 40 need not include the input apparatus 42 and the display apparatus 43.

The game G in the embodiment of the present invention is provided by the game server 40. The game server 40 is a server accessed by a player terminal (not shown) such as a smartphone when an ordinary player actually plays the game. The game server 40 is configured to store an application for the game (game program) and to be connected via a network to a player terminal of each player who plays the game. In one example, when a prescribed game app A is started on the player terminal, the player terminal communicates with the game server 40, and the game server 40 sends data to and receives data from the player terminal as needed to provide the game service. In one example, while the game app A is running on the player terminal, the game server 40 communicates with the player terminal regularly or intermittently, executes the game in accordance with game operation inputs at the player terminal, and sends the results of the execution to the player terminal.

In one example, the game server 40 stores player IDs and information concerning players in relation to the game in association with each other in the storage apparatus 44. In one example, the game server 40 receives a player ID and a password from a player terminal to authenticate a player and provides the game service (game G) to the player terminal by using data stored in association with the player ID of the authenticated player. Once the player ID is authenticated, the game server 40 can store data in association with the player ID until the game is finished or a log-out operation is accepted. For example, when a player terminal has been connected to the game server 40 and has been identified and authenticated by using a player ID and a password or the like, it becomes possible for the player to play the game G as the player having the player ID via the player terminal. The game server 40 stores game logs, which are log data concerning the game, while the player terminal executes the game G, for example, while the player terminal executes the game app A. Game logs stored by the game server 40 are generated by game plays by ordinary players (ordinary users).

The following describes specifics of the game G in the embodiment of the present invention.
The game G includes a plurality of quests, which are battle games in which ally characters play battles against enemy characters, as will be described later, and the order of the individual quests is predefined or is set according to prescribed rules. The game G may also include battle games other than quests.
Each quest has a quest ID associated therewith and has an opening condition set therefor. Examples of the opening condition include the condition that the player level is higher than or equal to a prescribed value and the condition that another prescribed battle game has been cleared. Each player can play only battle games for which the opening condition is satisfied.
Each player can configure a party by selecting a plurality of characters from among ally characters that the player possesses via a party configuration screen (not shown). The party configuration screen may be displayed before a battle game in a quest is started or may be displayed by accepting selection of a button for the party configuration screen from a home screen (not shown). Although the embodiment of the present invention is described in the context of the case where the player can configure a party by selecting five characters for convenience of description, there is no limitation to this case.
By using the ally characters in the party, each player can play a plurality of kinds of quests including enemy characters with different statuses or attributes or having different difficulty levels. It is possible to clear a quest when the ally characters included in the party defeat enemy characters. In the case where a quest has been cleared, the player who has cleared the quest can acquire a reward. The difficulty level of clearing a quest generally becomes higher as the player proceeds with quests.
When a battle game in a quest has been finished, a clear flag indicating a clear rank is associated in accordance with the status of clearing. The clear flag indicates one of the following: “3” corresponding to star×3 (three star symbols) indicating full marks (e.g., clearing in a state where all the ally characters have survived); “2” corresponding to star×2 (two star symbols) indicating clearing at an intermediate level (e.g., clearing in a state where three or four ally characters have survived); “1” corresponding to star×1 (one star symbol) indicating other kinds of clearing (e.g., clearing in a state where one or two ally characters have survived); and “0” corresponding to star×0 indicating a failure to clear. The reward acquired by the player varies depending on the clear rank.
The game G includes an auto-play mode function, and the player need not perform operations in a quest in the case where the player has selected the auto-play mode.

The following describes specifics of each player in the game G in the embodiment of the present invention.
Each player can possess ally characters, and the character IDs of the possessed ally characters are stored in association of the player ID of the player himself or herself. Each player can confirm all the ally characters possessed by the player via an ally-character confirmation screen (not shown). Each player can acquire ally characters, for example, by using rewards in the game, through free or charged lottery processing, or rewards for clearing quests. When a new ally character has been acquired, the ally character ID of the acquired ally character is stored in association with the player ID of the player.
With each player ID, a player level indicating the level of the player is stored in association. The player can confirm his or her own player level in a game screen.
Each player can acquire a prescribed value as a player experience value upon clearing a quest. The player level is raised each time the player experience value reaches a certain value. The current level of the player serves as an upper limit value for the levels of the ally characters. When the player level is raised by a prescribed value, the upper limit value for the character levels of the ally characters, which will be described later, are similarly raised by the prescribed value.
With each player ID, play information (e.g., the period in which the game was started and the date and time of the most recent log-in) of the player is stored in association.

The following describes specifics of characters in the game G in the embodiment of the present invention.
With each ally character (character ID), various kinds of status information (status data) are stored in association. For example, the status information includes ability values such as an offense level and a defense level, a rarity, an experience value, a character level, equipment, an equipment level, a character rank, and attributes (the type as to front/middle/back, the type as to physical/magical/versatile, etc.).
The rarity refers to the rarity of the ally character, defined by the game developer or the game administrator. Specifically, rarity is a kind of parameter expressed in terms of the number of stars or as rare (R), super-rare (SR), or the like. Each character has an initial rarity set therefor when acquired. There is a tendency that characters with lower winning probabilities in lottery processing and characters that can be acquired as rewards for clearing quests with high difficulty levels have higher initial rarities, resulting in low possession rates among players. Conversely, there is a tendency that the possession rates of ally characters with lower initial rarities are high even among novices. Note that rarities may be variable in the game, and the arrangement may be such that the basic ability values of ally characters are enhanced by enhancing the rarities of the ally characters by using items, combination processing, or the like.
The experience value is increased, for example, in the case of a victory in a quest or in the case where a prescribed item has been used. The character level is set in accordance with the experience value, and the character level is increased each time the experience value reaches a prescribed value. For example, each ally character has set therefor an upper limit value for the character level corresponding to the player level, as mentioned earlier. The character level is increased only within the range up to the upper limit value by using various kinds of items. For example, each ally character, on the basis of the character level, has set therefor base values corresponding to life points and battle abilities such as the offence level and the defense level, and each of the base values set to each ally character is increased as the level thereof becomes higher.
The equipment is equipment items such as weapons and armors that each ally character is equipped with, which can be acquired by purchasing at a shop in the game, by using rewards for quests, or the like. For example, each equipment item has set therefor addition values for the offence level, the defense level, etc., and when an ally character becomes equipped with equipment items, the addition values of each of the equipment items are added to the base values mentioned above, which makes it possible to enhance various kinds of abilities of ally characters. Each item of equipment has set therefor a character level at which it becomes possible to be equipped therewith, and it becomes possible to be equipped with stronger equipment items by enhancing the character level. Furthermore, each item of equipment has an equipment level set therefor. As the equipment level becomes higher due to the use of various kinds of items, higher addition values for the offense level, the defense level, etc. are set, and each item of equipment has set therefor an upper limit value of the equipment level.
The character rank can be enhanced by collecting and using specific items of equipment, which makes it possible to enhance various kinds of abilities of ally characters and to further acquire skills that can be used in quests.
The attributes are attributes associated with characters. For example, the attributes are metadata such as the type as to tank/front/middle/back, indicating the positioning of the party in a quest, and physical/magical/versatile, indicating the favorite styles of offense and defense. These attributes are information taken into consideration by each player when configuring a party. In one example, further classes may be defined within the same attribute. For example, rare versatility with higher performance or aptitude and common versatility with lower performance or aptitude may be provided. Note that enemy characters also have attributes similarly to ally characters, and the choice of the attributes of ally characters to be included in the party is important in clearing quests.

The rarity, the character level, the equipment level, and the character rank described above, which make it possible to enhance abilities of ally characters in the game G, will be collectively referred to as character status levels for convenience in this embodiment. The character status levels may mean one of levels (ranks) such as the rarity, the character level, the equipment level, and the character rank, or may mean other levels (ranks).

In the embodiment of the present invention, the game logs stored in the game server 40 include, for each single quest, party configuration characters, which are the ally characters constituting the party, the status information of the individual party configuration characters, and replay data at the time of clearing the quest. The status information includes the character status levels. In the embodiment of the present invention, ally characters may be simply expressed as characters.

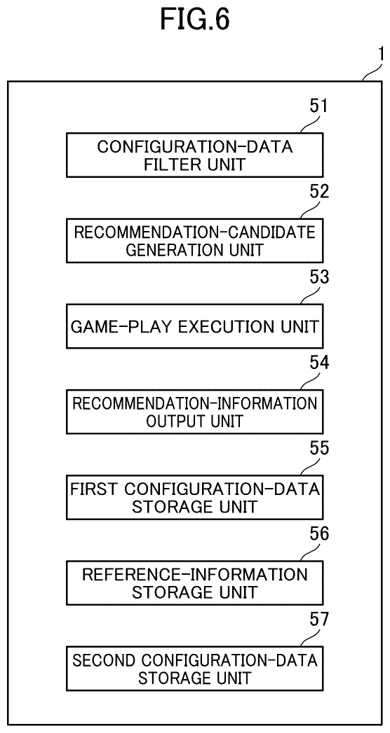

FIG. 6 is an example functional block diagram of the system 1 in the embodiment of the present invention. The system 1 includes a configuration-data filter unit 51, a recommendation-candidate generation unit 52, a game-play execution unit 53, a recommendation-information output unit 54, a first configuration-data storage unit 55, a reference-information storage unit 56, and a second configuration-data storage unit 57.

In the case where each of the recommendation apparatus 10, the virtual instance server 20, the test game server 30, and the game server 40 is realized by one or more apparatuses, these functions provided in the system 1 is realized, for example by executing programs by at least one of the processor 11, the processor 21, the processor 31, and the processor 41 and storing data in at least one of the storage apparatus 14, the storage apparatus 24, the storage apparatus 34, and the storage apparatus 44 as needed, or in addition by passing or receiving data as needed between two or more apparatuses among the recommendation apparatus 10, the virtual instance server 20, the test game server 30, and the game server 40. For example, the individual storage units 55, 56, and 57 may be realized by storing data (e.g., tables) and programs for a database in one of the storage apparatus 14, the storage apparatus 24, the storage apparatus 34, and the storage apparatus 44 and executing the programs by one of the processor 11, the processor 21, the processor 31, and the processor 41. Since various kinds of functions are realized by loading programs, as described above, one functional unit (e.g., a software module) may be provided in another functional unit in part or in entirety. Alternatively, the individual storage units 55, 56, and 57 may be realized by one of the storage apparatus 14, the storage apparatus 24, the storage apparatus 34, and the storage apparatus 44. For example, in the case where the recommendation apparatus 10, the virtual instance server 20, and the test game server 30 are realized by using a virtual environment, these functions provided in the recommendation system 2 can be realized by the operations of individual constituent elements equivalent to the operations in the case where each of the recommendation apparatus 10, the virtual instance server 20, and the test game server 30 is realized by using one or more apparatuses.

The game logs stored in the game server 40 at least include, as game logs concerning quests, configuration data including information concerning parties (party configurations). Among the game logs stored in the game server 40, the first configuration-data storage unit 55 stores first configuration data including information concerning parties among game logs for individual cleared quests. The first configuration data can be referred to as cleared configuration data associated with real users. As the first configuration data stored in the first configuration-data storage unit 55, the game log data acquired from the game server 40 may be used as is, or data generated on the basis of game logs may be used. In one example, the recommendation apparatus 10 can acquire game logs from the game server 40 and can extract or generate, from the acquired game logs, first configuration data including information concerning parties in game logs for individual cleared quests. The first configuration data includes the player ID of the player who played the quest, the player level of the player, the quest ID, the five party configuration characters (cleared party associated with a real user), and the status information of the individual party configuration characters. The first configuration data may include a clear flag indicating the clear rank. The first configuration-data storage unit 55 can be realized by the recommendation apparatus 10.

In one example, the first configuration data stored in the first configuration-data storage unit 55 may be data generated or extracted from game logs of the first clears of individual quests among the game logs stored in the game server 40. For example, in this case, the recommendation apparatus 10 can generate first configuration data by extracting (acquiring) game logs of the first clears of individual quests from the game logs acquired from the game server 40 or by acquiring game logs of the first clears of individual quests from the game server 40. In one example, the first configuration data stored in the game server 40 may be data generated or extracted from game logs of cleared (irrespective of the specifics) individual quests among the game logs stored in the game server 40. For example, in this case, the recommendation apparatus 10 can generate first configuration data by extracting (acquiring) game logs of cleared individual quests from the game logs acquired from the game server 40 or by acquiring game logs of cleared individual quests from the game server 40. In one example, the first configuration data stored in the first configuration-data storage unit 55 may be data generated or extracted from game logs of individual quests cleared with a certain grade or higher or while satisfying a condition (e.g., cleared with the clear rank of star×3 (three star symbols)) among the game logs stored in the game server 40. For example, in this case, the recommendation apparatus 10 can generate first configuration data by extracting (acquiring) game logs of individual quests cleared with a certain grade or higher or while satisfying a condition (e.g., cleared with the clear rank of star×3 (three star symbols)) from the game logs acquired from the game server 40 or by acquiring game logs of individual quests cleared with a certain grade or higher or while satisfying a condition.

In one example, the first configuration data may be table data of a database. For example, in this case, the arrangement may be such that items corresponding to the quest ID, the player ID, the player level, the clear flag, and the unit data are arranged in the column direction (as columns), data are accumulated one by one in the row direction, and the data on each row (record) is stored in association with the player ID and the quest ID. In this case, the unit data includes five party configuration characters (a party) and the status information of those characters, and for example, text data written in JSON is stored as data for searching. Furthermore, in this case, it suffices for the status information stored in the unit data to include preset information needed by the system 1 in order to present recommendation information to players among the status information defined in the game G. The data structure of the first configuration data is not limited to the data structure in this example. However, in the following description, for convenience of description, of the first configuration data, it is possible to refer to data of one quest cleared once by one player as one record. Note that the first configuration data may mean one record (data of an i-th quest i cleared), the party configuration characters in one record, or the party configuration characters in one record and the status information of those characters.

The configuration-data filter unit 51 narrows down (extracts) first configuration data relating to game logs of players satisfying a prescribed condition among the first configuration data stored in the first configuration-data storage unit 55. For example, the configuration-data filter unit 51 extracts records associated with the player IDs of players satisfying a prescribed condition from the first configuration data stored in the first configuration-data storage unit 55. The configuration-data filter unit 51 can be realized by the recommendation apparatus 10. In one example, on the basis of play information associated with player IDs, for example, first configuration data associated with the player IDs of players who started the game in the recent six months or who logged in at least once in the recent three months are extracted (acquired).

The reference-information storage unit 56 stores per-quest estimated player levels (data), the first configuration data, and a character list arranged in order of priority level. The reference-information storage unit 56 is realized by the recommendation apparatus 10. In one example, the per-quest estimated player level data, the first configuration data, and the character list arranged in order of priority level may be realized individually by using different databases or apparatuses.

The per-quest estimated player levels stored in the reference-information storage unit 56 are estimated or recommended player levels of players of individual quests. The per-quest estimated player levels are per-quest estimated player levels calculated or derived from the game logs stored in the game server 40 or from the first configuration data stored in the first configuration-data storage unit 55. For example, the per-quest estimated player levels are the lowest value of the player level at which the first clear is possible, the mode of the player levels of players who accomplished first clears, the mode within a prescribed range of the player levels of players who accomplished first clears, or other recommended player levels, for each quest.

The first configuration data stored in the reference-information storage unit 56 is first configuration data extracted by the configuration-data filter unit 51.

The character list arranged in order of priority level, stored in the reference-information storage unit 56, is a list of all characters arranged in ascending order of in-game value for each quest, in which a higher priority level is set as the in-game value becomes lower. In the embodiment of the present invention, the in-game value is an index indicating a value of each character in the game G. In one example, the in-game value may be an index determined on the basis of some or all of the rate of possession among players and the levels (e.g., the rarity and the character level) included in the character status levels, or the in-game value may be one of these factors (e.g., one of the rate of possession among players, the rarity, and the character level). Alternatively, in one example, the in-game value may be an index arbitrarily determined by the game developer, and it is also possible to feature (emphasize) specific characters. Characters having higher character status levels are characters whose abilities have been improved by players with more labor and costs or high-ability characters acquired by players with more labor and costs, and the values thereof become higher. Thus, the in-game value of a character becomes higher as the character status levels thereof become higher. In one example, as the possession rate of a character among players becomes lower, the difficulty of the acquisition thereof becomes higher, and the value thereof becomes higher. Thus, the in-game value may be arranged so as to become higher as the possession rate of a character among players becomes lower. In one example, the character list arranged in order of priority level is a list in which all characters are arranged in ascending order of character status levels for each quest, and may be arranged as a list in which a higher priority level is set as the character status levels become lower. For example, the character list arranged in order of priority level is a list in which all characters are arranged in ascending order of rarity, i.e., in ascending order of the difficulty of acquisition, for each quest, in which a higher priority level is set as the rarity becomes lower. For example, the rarity for each quest may be a rarity at an estimated player level for the quest or at a player level within a range preset with reference to the estimated player level. In one example, each character in the character list arranged in order of priority level has associated therewith at least a portion of the status information, such as attributes. The character list arranged in order of priority level may be generated (updated) by the game developer or the game administrator at regular timings or prescribed timings such as after adjusting balance, or may be automatically generated (updated) according to a program for calculating various kinds of indices and checking a prescribed condition. Note that the character list arranged in order of priority level may be something other than a list as long as equivalent data is stored therein, or may be a list in which priority ranks are set instead of priority levels. Furthermore, whatever method is used to generate (update) the character list arranged in order of priority level, it can be said that priority levels or priority ranks referred to by the system 1 are preset priority levels or priority ranks.

The recommendation-candidate generation unit 52 generates a recommendation candidate party for one quest, which is a party for clearing the one quest, by replacing some of the ally characters constituting a party with other characters on the basis of the information stored in the reference-information storage unit 56. The recommendation-candidate generation unit 52 generates, for each of all the quests in the game G, a recommendation candidate party for clearing that quest. The recommendation-candidate generation unit 52 can be realized by the recommendation apparatus 10. In one example, in the case where the first configuration data stored in the first configuration-data storage unit 55 is data generated or extracted from game logs of individual quests cleared with a certain grade or higher or while satisfying a condition among the game logs stored in the game server 40, the recommendation-candidate generation unit 52 may be configured to generate a recommendation candidate party for clearing one quest with the certain grade or higher or while satisfying the condition. In one example, the recommendation-candidate generation unit 52 can generate recommendation-candidate configuration data including a quest ID, five party configuration characters constituting a recommendation candidate party, and the status information of the individual party configuration characters. In one example, the recommendation-candidate generation unit 52 can generate recommendation-candidate configuration data including a recommendation candidate party, which is a party for clearing each quest, by replacing some of the party configuration characters with other characters in each of the records associated with that quest in the first configuration data stored in the reference-information storage unit 56. In one example, the recommendation-candidate configuration data may be data including a quest ID, a player level, and unit data in the column direction (as columns).

In one example, the recommendation-candidate generation unit 52 generates a recommendation candidate party for each quest by replacing n ally characters having high in-game values among the party configuration characters with the top n characters in the character list arranged in order of priority level with reference to the character list arranged in order of priority level on a per-quest basis by using, among records associated with one quest, records of players having the estimated player level of the one quest or having player levels within a range preset with reference to the player level in the first configuration data stored in the reference-information storage unit 56 with reference to the per-quest estimated player level data. In one example, the recommendation-candidate generation unit 52 can generate a recommendation candidate party for each quest by replacing n ally characters having high rarities among the party configuration characters with the top n characters in the character list arranged in order of priority levels. Since a party is constituted of five ally characters, n can be set to an arbitrary natural number from one to four.

The recommendation-candidate generation unit 52, for each quest, can replace n ally characters having high rarities or one to n ally characters having rarities higher than or equal to a prescribed level with the top ally characters in the character list arranged in order of priority level in each record associated with one quest in the first configuration data stored in the reference-information storage unit 56. For example, in the case where n is set to two, the recommendation-candidate generation unit 52 may be configured to necessarily replace two ally characters having higher rarities in each record associated with one quest in the first configuration data stored in the reference-information storage unit 56, or to replace one ally character in the case where there are not two ally characters having rarities higher than or equal to a prescribed level.

In one example, the recommendation-candidate generation unit 52 can generate a plurality of kinds of recommendation candidate parties from one record associated with one quest. In this example, for example, in the case where n is set to one, it is possible to generate k kinds of recommendation candidate parties by replacing one ally character with the top k characters among the characters arranged in order of priority level in one record associated with one quest.

In one example, the recommendation-candidate generation unit 52, for each quest, can replace n ally characters with the top ally characters in the character list arranged in order of priority level among ally characters having high compatibility with (e.g., having the same attributes as) the individual ally characters in each record associated with one quest in the first configuration data stored in the reference-information storage unit 56. In this example, for example, in the case where n is set to one and the attributes of ally characters that are replaced are the attributes of front and physical, the recommendation-candidate generation unit 52 replaces the ally characters with the top characters having front and physical or front and versatile attributes in the character list arranged in order of priority level. In this example, for example, in the case where n is greater than or equal to two, replacement is performed individually with the top characters individually having compatibility with the ally characters that are replaced in the character list arranged in order of priority level. In one example, the recommendation-candidate generation unit 52, with reference to the status information of characters, can dynamically calculate the compatibility of the top characters in the character list arranged in order of priority level in relation to the ally characters that are replaced, and can determine those characters as characters to be used for replacement (characters having high compatibility) in the case where the evaluation values are high, for example, in the case where the evaluation values are greater than or equal to a prescribed value. For example, the recommendation-candidate generation unit 52 may be configured such that the evaluation values of characters having many matching attributes among a plurality of attributes such as tank/front/middle/back and physical/magical/versatile in the status information of characters become high. For example, the recommendation-candidate generation unit 52 may be configured to calculate evaluation values while considering that attributes always match for characters acting as tanks, without distinction among physical/magical/versatile. For example, the recommendation-candidate generation unit 52 may be configured to decrease the evaluation value for a change from the versatile attribute to another attribute and to increase the evaluation value for replacement with versatile for some characters.

In one example, the recommendation-candidate generation unit 52 can set the ally characters not replaced in the generated recommendation candidate party to the character status levels associated in the original first configuration data and can set the ally characters used for replacement to the lowest level that makes it possible to clear the quest, preset in accordance with the quest, and the neighboring levels thereof. In one example, the recommendation-candidate generation unit 52 can set all the ally characters in the generated recommendation candidate party to the lowest level that makes it possible to clear the quest, preset in accordance with the quest, and the neighboring levels thereof.

The recommendation-candidate generation unit 52 generates a plurality of kinds of recommendation candidate parties for each of all the quests in the game G.

The game-play execution unit 53 performs game plays by using the recommendation candidate parties generated by the recommendation-candidate generation unit 52 and extracts (determines) parties with which quests have been cleared. In one example, for each of all the quests in the game G, the game-play execution unit 53, by using the recommendation candidate parties for clearing one quest, generated by the recommendation-candidate generation unit 52, executes auto-plays (auto-plays using an auto-play function of the game system or using external AI, or auto-plays using a simple auto-pilot function) of the one quest, thereby extracting a recommendable party, which is a party with which the one quest has been cleared. In one example, the game-play execution unit 53 can play one quest by using recommendation candidate parties for clearing the one quest with a prescribed grade or higher. In one example, the game-play execution unit 53 can play one quest by using recommendation candidate parties for clearing the one quest with a prescribed grade or higher and with a minimum necessary level. In one example, when playing the one quest by using a recommendation candidate party, the game-play execution unit 53 can set the character status levels of the ally characters constituting the party to prescribed levels corresponding to the one quest (e.g., the minimum necessary levels for clearing the one quest). In one example, when playing one quest by using a recommendation candidate party, the game-play execution unit 53 can set the character status levels of the ally characters constituting the party in accordance with the estimated player level of the one quest or player levels within a range preset with reference to the player level.

The game-play execution unit 53, on a per-quest basis, extracts the recommendable party with which each quest has been cleared and stores the extracted recommendable party in the second configuration-data storage unit 57. In one example, the game-play execution unit 53 can extract (generate) recommendable configuration data including a quest ID, five party configuration characters constituting a recommendable party and the status information of the individual party configuration characters and can store the generated recommendable party in the second configuration-data storage unit 57.

In the embodiment of the present invention, the game-play execution unit 53 is realized mainly by the virtual instance server 20 and the test game server 30. The virtual instance server 20 generates a plurality of virtual instances for virtualizing a player terminal (user terminal) for playing the game or the software environment of the player terminal according to a control signal from the recommendation apparatus 10. The virtual instances are virtual instances for executing the game G and are configured to be connected to the test game server 30 so as to be able to execute the game G. When the game G is executed in one virtual instance, the virtual instance server 20 sets the party for clearing one quest, generated by the recommendation-candidate generation unit 52, and executes a game play (auto-play) of the one quest.

The virtual instances are virtual instances for virtualizing a player terminal or the software environment of a player terminal, and can be realized by using, for example, virtualization technology at the operating system level, called “containers”, such as docker (registered trademark). With docker (registered trademark), by controlling Linux (registered trademark) containers provided by the Linux (registered trademark) kernel, it is possible to provide process-based virtualization, i.e., a space in which the use of a CPU and the use of a file system are separated from other processes. Since the individual containers are mutually separated, it becomes possible for each of the containers to behave like the only game app operating in the operating system. Thus, it is possible to virtually realize the execution of game apps at a player terminal by executing the game apps in the individual containers and activating processes for the game apps. Therefore, it is possible to generate a plurality of virtual instances at the virtual instance server 20 and to simultaneously execute a plurality of game apps in parallel in an isolated manner, thereby generating verification results. In the embodiment of the present invention, it is possible to use “containers” of docker (registered trademark) as virtual instances, and for example, it is possible to consider each of the virtual instances as a virtualized smartphone.

In one example, a virtual instance can execute the game G by executing a game app A in a headless mode, which is executed in order to play the game at a player terminal. For example, the virtual instance server 20 can execute the game G by executing the game app A in an auto-pilot manner in a headless mode in a virtual instance or while virtualizing a GPU and a sound device so that at least graphic processing and sound processing are substantially disabled, the game app A being executed in order to play the game at a player terminal. Here, disabling graphic processing and sound processing includes substantial disabling through virtualization or redirection.

In one example, the game-play execution unit 53 can be implemented by AI auto-play on preforkd. preforkd is considered as an automated debugging system based on AI agents with which games are played while being virtualized on an end to end basis and activated in parallel in a large scale. With preforkd, virtualization and parallelization based on the functional paradigm are performed, which makes it possible, for example, to attain high density with which 90 to 210 game processes are run in a fully parallel manner on a single server having 96 virtual CPUs. This makes it possible to execute not less than 140 thousand quests per day.

Since the game-play execution unit 53 can execute game plays by executing games by using virtual instances, as described above, AI can execute auto-plays of individual quests in a large-scale simulation environment.

The second configuration-data storage unit 57 stores a recommendable party for each quest. In one example, the second configuration-data storage unit 57 stores recommendable configuration data, and each record in the recommendable configuration data is stored in association with a quest ID. The recommendable configuration data may have the same data structure as the recommendation-candidate configuration data. The recommendable configuration data may be referred to as cleared configuration data associated with AI. The second configuration-data storage unit 57 can be realized by the recommendation apparatus 10.

The recommendation-information output unit 54 outputs (transmits) recommendation information to the player terminal of one player on the basis of the ally characters possessed by the one player, the recommendation information including one or more parties among the recommendable parties stored in the second configuration-data storage unit 57. The recommendation-information output unit 54 can be realized by the recommendation apparatus 10 and the game server 40. In one example, the recommendation information may include recommendable configuration data. In one example, it suffices for the recommendation information to be such information that, when received by the game server 40, makes it possible for the game server 40 to present the player with information indicated by the recommendation information, such as one or more recommendable parties, for example, via the player terminal.

In one example, the recommendation-information output unit 54, in response to a request for a recommendable party for a specific quest from the player terminal of one player, can output one or more recommendable parties from the recommendable parties stored in the second configuration-data storage unit 57 to the player terminal of the one player on the basis of the ally characters possessed by the player.

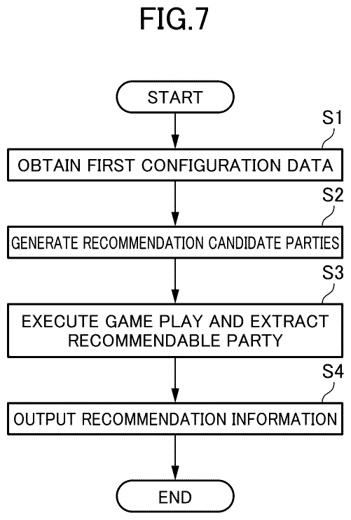

FIG. 7 is a figure for explaining an example flowchart of processing by the system 1 in one embodiment of the present invention.

In step S1, the recommendation system 2 acquires (extracts) first configuration data relating to game logs of players satisfying a prescribed condition among the first configuration data stored in the first configuration-data storage unit 55 and stores the acquired first configuration data in the reference-information storage unit 56. In step S2, the recommendation-candidate generation unit 52 generates recommendation candidate parties for each of all the quests in the game G on the basis of the information stored in the reference-information storage unit 56. In step S3, for each of all the quests in the game G, the game-play execution unit 53, by using the recommendation candidate parties for clearing one quest, generated by the recommendation-candidate generation unit 52, executes auto-plays of the one quest and extracts a recommendable party with which the one quest has been cleared. In step S4, on the basis of the ally characters possessed by one player, the recommendation-information output unit 54 outputs recommendation information from the recommendable parties stored in the second configuration-data storage unit 57.

Next, the main operations and advantages of the system 1 in the embodiment of the present invention will be described.

One of the technical features of the system 1 in the embodiment of the present invention is that editing is performed to replace ally characters that are difficult to acquire with ally characters that are easier to acquire by using, as materials, parties (party configurations) created by existing players, with which quests have been actually cleared, and test plays are performed with the edited parties in a large-scale simulation environment.

With this configuration, it is possible to generate or extract and output a party with which it is possible to clear each quest and that has a relatively low difficulty of acquisition for being presented to a player. There has not been such a technology for recommending parties on the basis of evidence of actual clears, and the system 1 in the embodiment of the present invention makes it possible to realize such a technology. This makes it possible to solve the cold start problem and the exposure bias problem, which have hitherto existed.

Note that it suffices for the function of auto-editing using configurations created by existing players as materials to involve replacement with ally characters with higher availability (i.e., lower rarity), not depending on any specific algorithm. Furthermore, the auto-play algorithm for performing auto-plays with the results of auto-editing in a simulation environment does not depend on any specific implementation.

Furthermore, in the embodiment of the present invention, since the recommendation system 2 can be implemented as off-line batch processing separated from the game server 40 that is running the service, it is possible to realize the recommendation system 2 without increasing the runtime load of the service.

The operations and advantages described above also apply to other embodiments and modifications unless otherwise specifically mentioned.

A system in an embodiment of the present invention may be either the system 1 or the recommendation system 2 described above. Therefore, the game server 40 need not be provided in an embodiment of the present invention. An embodiment not including the game server 40 will be described later.

The system 1 in the embodiment of the present invention may be a single apparatus. In this case, the system 1 may be realized by using a virtual environment in which virtualization of all the constituent elements is realized. An embodiment of the present invention may be a method or program for realizing the functions of the system 1 or the recommendation system 2 or the information processing shown in the flowchart, described above, or a computer-readable storage medium storing the program. Alternatively, an embodiment of the present invention may be a server that can provide a computer with a program for realizing the functions or the information processing shown in the flowchart of the above-described embodiment of the present invention. The same applies to other embodiments and modifications.

The specifics of the game G described above in the context of the embodiment of the present invention is an example, and there is no limitation thereto. In embodiments of the present invention, the game G is not limited to any specific game and may be a game to which the system in an embodiment of the present invention is applicable. In embodiments of the present invention, a quest may be an arbitrary game other than a quest, for which a game play is performed by using a game medium set such as a party (party configuration), a card deck configuration, or a combination of character equipment items, which can be referred to as a unit game in the present description. The unit game is a concept including a quest. Furthermore, in embodiments of the present invention, a clear is a concept including the achievement of a certain result or better by a player in a unit game, such as a victory in a battle game or the acquisition of a prescribed score or higher in other games. Furthermore, for example, five party configuration characters is an example, and the number of party configuration characters in the game G can be set to an arbitrary number. Furthermore, for example, the information included in the status information described earlier is an example, and there is no limitation thereto. In addition, the specifics of the game G described earlier is an example, and there is no limitation thereto.

In one or more embodiments of the present invention, the game G may be a battle game in which two or more players participate. In this embodiment, the game server 40 may be configured to execute player matching processing, and the game-play execution unit 53 may also be configured to execute player matching processing.

In one or more embodiments of the present invention, the first configuration-data storage unit 55 may be realized by an arbitrary apparatus of the game server 40 or the recommendation system 2. In one or more embodiments of the present invention, the configuration-data filter unit 51 may be realized by an arbitrary apparatus of the game server 40 or the recommendation system 2. In one or more embodiments of the present invention, the reference-information storage unit 56 may be realized by an arbitrary apparatus of the recommendation system 2. In one or more embodiments of the present invention, the second configuration-data storage unit 57 may be realized by an arbitrary apparatus of the game server 40 or the recommendation system 2.

In one or more embodiments of the present invention, the first configuration data stored in the first configuration-data storage unit 55 may be data extracted or generated from game logs of the first clears of individual quests among the game logs stored in the game server 40. With this configuration, the system 1 can generate recommendation candidate parties (recommendation-candidate configuration data) based on party configurations on the occasions of the first clears by players, in which the ingenuity of the players in configuring parties is more strongly reflected, and can determine recommendable parties (recommendable configuration data). This makes it possible to further improve the accuracy of recommendation.

In one or more embodiments of the present invention, the first configuration data stored in the first configuration-data storage unit 55 may be data generated or extracted from game logs of individual quests cleared with a certain grade or higher or while satisfying a condition (e.g., cleared with the clear rank of star×3 (three star symbols)) among the game logs stored in the game server 40. With this configuration, it becomes possible for the system 1 to determine even better recommendable parties (recommendable configuration data), which makes it possible to further improve the accuracy of recommendation.

In one or more embodiments of the present invention, the first configuration data stored in the first configuration-data storage unit 55 can also be generated from game logs generated through game plays by the game-play execution unit 53. In this embodiment, for example, the recommendation apparatus 10 can generate first configuration data including information concerning parties in game logs of cleared individual quests from game logs acquired from the game server 40 and game logs generated through game plays by the game-play execution unit 53. With this configuration, even in the case where it is not possible to acquire, from the game server 40, game logs sufficient to generate a recommendation candidate party (recommendation-candidate configuration data) or a recommendable party (recommendable configuration data), it is possible to generate or extract and output a party with which it is possible to clear each quest and that has a relatively low difficulty of acquisition for being presented to a player.

In the embodiment of the present invention, since the system 1 includes the configuration-data filter unit 51, it becomes possible to exclude clear histories of users who have left and clear histories that have become old through game balance adjustment or the like, which are accumulated as the game is run for a long period, thereby utilizing the most recent play history data (game logs) as much as possible. Furthermore, with this configuration, it becomes possible to narrow down data for reference from a large volume of game logs generated by the game server 40, which makes it possible to prevent combinatorial explosions.

In one or more embodiments of the present invention, the system 1 need not include the configuration-data filter unit 51. In this embodiment, the first configuration data need not include the player IDs of players who have played the game. In this embodiment, the first configuration data stored in the reference-information storage unit 56 may be the same as the first configuration data stored in the first configuration-data storage unit 55, or the reference-information storage unit 56 need not store first configuration data. In the case where the reference-information storage unit 56 does not store first configuration data, the recommendation-candidate generation unit 52 can use the first configuration data stored in the first configuration-data storage unit 55 instead of the first configuration data stored in the reference-information storage unit 56. For example, in this case, the recommendation-candidate generation unit 52 can generate a recommendation candidate party for one quest, which is a party for clearing the one quest, by replacing some of the ally characters constituting a party with other characters on the basis of the first configuration data stored in the first configuration-data storage unit 55 as well as the per-quest estimated player level and the character list arranged in order of priority level stored in the reference-information storage unit 56. For example, in this case, the flowchart shown in FIG. 7 need not include step S1, and in step S2, the recommendation-candidate generation unit 52 can generate a recommendation candidate party for each of all the quests in the game G on the basis of the first configuration data stored in the first configuration-data storage unit 55 as well as the per-quest estimated player level and the character list arranged in order of priority level stored in the reference-information storage unit 56. Even in this embodiment, the main operations and advantages of the system 1 described above can be afforded.

In the embodiment of the present invention, since the system 1 includes the recommendation-candidate generation unit 52, it becomes possible to generate parties having low difficulties of acquisition by using, as materials, parties with which quests have been actually cleared. The rarity described in the context of the embodiment of the present invention is an example in-game value. For example, the recommendation-candidate generation unit 52 can generate a recommendation candidate party by replacing n ally characters with low rate of possession among players at a prescribed timing or during a prescribed period among party configuration characters with the top n characters in the character list arranged in order of priority level.

In one or more embodiments of the present invention, the recommendation-candidate generation unit 52 may be configured to generate recommendation candidate configuration data (recommendation candidate parties) for each of subject quests (some or specific quests) instead of all the quests in the game G. In this case, the first configuration data may be configured to include only records relating to quests, generated by the recommendation-candidate generation unit 52. For example, in this case, the recommendation apparatus 10 can generate first configuration data by extracting (acquiring) game logs of cleared subject quests from the game logs acquired from the game server 40 or by acquiring game logs of cleared subject quests from the game server 40.

In the embodiment of the present invention, the reference-information storage unit 56 stores per-quest estimated player levels. Thus, it becomes possible for the recommendation-candidate generation unit 52 to generate a recommendation candidate party for clearing one quest i by referring to a player level that serves as a reference when generating a configuration with which it is possible to actually clear the one quest i, which may be deviated from a recommended player level set at the time of game development.

In one or more embodiments of the present invention, the recommendation-candidate generation unit 52 can generate a recommendation candidate party by using, of the first configuration data stored in the reference-information storage unit 56, all the records associated with one quest or specific records irrelevant to the estimated player level of the one quest. Alternatively, in one or more embodiments of the present invention, the first configuration data stored in the first configuration-data storage unit 55 may be data extracted or generated from game logs of cleared individua quests among the game logs stored in the game server 40. Also with this embodiment, the main operations and advantages of the system 1 described above can be afforded. In this case, the reference-information storage unit 56 need not store per-quest estimated player levels.

In one or more embodiments of the present invention, player levels need not be set in the game G.

In the embodiment of the present invention, for example, the character list arranged in order of priority level is a list in which all characters are arranged in ascending order of rarity on a per-quest basis. By referring to (using) the character list arranged in order of priority level, the recommendation-candidate generation unit 52 can generate a recommendation candidate party for each quest by replacing n ally characters with high rarities among party configuration characters with the top n characters in the character list arranged in order of priority level. The rarity described in the context of the embodiment of the present invention is an example in-game value. For example, the character list arranged in order of priority level is a list in which characters are arranged in descending order of the rate of possession among players at a prescribed timing or during a prescribed period, and may be a list in which a higher priority level is set as the possession rate becomes higher. As an example, the per-quest possession rate may be a possession rate at the per-quest estimated player level or player levels within a range preset with reference to the estimated player level. As another example, since there is a tendency that it becomes easier to acquire a character and the possession rate thereof becomes higher as the initial rarity of the character becomes lower, the character list arranged in order of priority level may be a list in which a higher priority is set as the initial rarity becomes lower.

In one or more embodiments of the present invention, the character list arranged in order of priority level is a list in which all characters are arranged in ascending order of in-game value, and may be a list shared among quests, not a list on a per-quest basis, in which a higher priority level is set as the in-game value becomes lower. For example, the recommendation-candidate generation unit 52 can generate a recommendation candidate party for each quest by replacing n ally characters with high in-game values among party configuration characters with the top n characters in the character list arranged in order of priority level, with reference to the character list arranged in order of priority level shared among quests, by using, among records associated with one quest in the first configuration data stored in the reference-information storage unit 56, records of players at the estimated player level of the one quest or at player levels within a range preset with reference to the player level with reference to the per-quest estimated player level data.

In one or more embodiments of the present invention, the character list arranged in order of priority level may be arranged such that priority levels or priority ranks in the character list arranged in order of priority level are set while considering, as priority levels, factors other than in-game values instead of or in addition to in-game values such as rarities in each of prescribed quests in the game G or in each of all the quests in the game G. In one example, priority levels or priority ranks may be determined in accordance with intents for rendition on the developer side, such as “configurations including a character that appeared in this month” or “a character that is hoped to play an important role in this event”. With this configuration, it is possible to express intents for rendition on the developer side in addition to “low rarities” and “high possession rates” in party auto-generation, which makes it possible to intentionally introduce new characters or the like in “featured recommendations”, thereby featuring the new characters or the like.

In one or more embodiments of the present invention, the game-play execution unit 53 can cause a virtual instance to execute a game play (AI auto-play) in a manual mode, which is not an auto-play mode. In one or more embodiments of the present invention, the game-play execution unit 53 can execute a game play by using a virtual environment in which virtual instances are not used. In one or more embodiments of the present invention, the virtual instance server 20 and the test game server 30 can be realized by using a virtual environment.

In the embodiment of the present invention, since the system 1 includes the recommendation-information output unit 54, it becomes possible for each player to select one or more party configurations constituted of ally characters possessed by the player in a game play. In one example implementation, the game may be configured such that objects such as “cleared parties” or “AI featured configuration” are disposed in a party configuration screen, and the recommendation system 2 (server side) can be configured to select records associated with a subject quest (a quest associated with a request from the player terminal) stored in the second configuration-data storage unit 57 when a player taps one of the objects at a player terminal. Since computation for this selection can be executed with a single SQL processing operation when the SQL IN operator is used, the selection can be implemented as processing with relatively low computation costs.

In one or more embodiments of the present invention, the recommendation-information output unit 54 need not be included in embodiments not including the game server 40. In this embodiment, the game-play execution unit 53 outputs recommendable configuration data (recommendable parties), for example, stores recommendable configuration data (recommendable parties) in the second configuration-data storage unit 57, which makes it possible to utilize the data. Therefore, in the embodiment of the present invention, it can be said that the main operations and advantages of the system 1 described above can be afforded if the system 1 is configured to output a party (output a game medium set). Furthermore, in embodiments not including the game server 40, the recommendation system 2 and the game server 40 need not be communicatively connected via the network 4. In this case, it suffices that the recommendation system 2 is configured to be able to acquire game logs from the game server 40 and that the game server 40 is configured to be able to acquire recommendable configuration data (recommendable parties) from the recommendation system 2.

In the embodiment of the present invention, the system 1 outputting a party (game medium set) to be presented to a player may mean a player terminal transmitting data for displaying a recommendable party on a display apparatus or storing such data in a storage apparatus of an arbitrary apparatus. Therefore, the system 1 outputting a party (game medium set) may mean outputting information concerning a party (game medium set).

In one or more embodiments of the present invention, the recommendation-candidate generation unit 52 can be realized by implementing a function defined as expression (1).

$${f}_{candidate} ( {D}_{i} ) \to {D}_{i}^{′} \qquad ( 1 )$$

Expression (1) is a function that receives, as an input, a set Dᵢ of cleared configuration data associated with advanced users who have cleared the i-th quest in the game G and that outputs a set D′ᵢ of more affordable configuration data in which characters that are difficult to possess for novice users, included in Dᵢ, are replaced with characters that are easy to possess for novice users.

In one or more embodiments of the present invention, the game-play execution unit 53 can let AI perform game plays in a large-scale simulation environment to verify, through simulation, that it is possible to clear the i-th quest with the j-th configuration included in Dᵢ′, expressed as:

$${d}_{i , j}^{′} ∈ {D}_{i}^{′}$$

A model of a function for performing this simulation can be expressed in the form of a function in expression (2).

$${f}_{simlulate} ( {D}_{i}^{′} ) \to {D}_{i}^{″} \qquad ( 2 )$$

Here, Dᵢ′ signifies the set of configuration data subject to simulation, and Dᵢ″ signifies the set of configuration data with which the quest i has been cleared as a result of the simulation.

In one or more embodiments of the present invention, the recommendation-information output unit 54, by narrowing down configurations on the basis of the sets of characters possessed by individual players, realizes recommendation of configurations that are personalized and for which clears are assured. A model of the process of the personalization can be expressed in the form of a function in expression (3).

$${f}_{personalize} ( {D}_{i}^{″} , {C}_{u} ) \to {D}_{i}^{p} \qquad ( 3 )$$

Cᵤ signifies the set of ally characters possessed by the u-th player, and Dᵢ^{p} signifies the set of configurations that include only ally characters possessed by a player p and with which it is possible to clear the quest i.

In the embodiment of the present invention, the headless mode is a mode in which graphic processing involving access to a GPU is disabled, and sound processing involving access to an acoustic source chip, as well as processing for access to an external server, are disabled. This makes it possible to execute a game in a state where only a CPU, a memory, and a secondary storage apparatus are used, i.e., only with access to resources closed within a container. This makes it possible to exclude speed limiting factors (factors that determine speed), such as an animation processing speed presupposing human viewing and audio reproducing speed presupposing human listening. Furthermore, considering that these graphic and sound devices are generally implemented as external devices provided outside a CPU, it is also possible to save wait times for synchronization associated with I/O processing between the CPU and the external devices. This makes it possible to run a game at high speed with no-wait processing, which depends only on the processing speed of the CPU alone, omitting rendition for humans and wait processing for waiting synchronization for external devices. This makes it possible to execute a game in a shorter time.

In one or more embodiments of the present invention, executing a game program (game app) in the headless mode may be either executing a game program in the headless mode or executing a headless game program. The execution may be in any manner as long as it is possible to proceed with a game in a headless state. With Unity, which is a widely used game engine, it is possible to readily generate a headless game program just by selecting the headless mode from a GUI. That is, it is possible to readily prepare a game program for verification by reusing a game program for player terminals. In one or more embodiments of the present invention, a game program may be executed in a normal mode, which is not the headless mode.

In one or more embodiments of the present invention, each of the functional units included in the system 1 may also be realized by hardware by configuring an electronic circuit or the like for realizing the functional unit in part or in entirety.

The processing or operation described above may be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1 System
2 Recommendation system
4 Network
10 Recommendation apparatus
11 Processor
12 Display apparatus
13 Input apparatus
14 Storage apparatus
15 Communication apparatus
16 Bus
20 Virtual instance server
21 Processor
22 Display apparatus
23 Input apparatus
24 Storage apparatus
25 Communication apparatus
26 Bus
30 Test game server
31 Processor
32 Display apparatus
33 Input apparatus
34 Storage apparatus
35 Communication apparatus
40 Game server
41 Processor
42 Display apparatus
43 Input apparatus
44 Storage apparatus
45 Communication apparatus
51 Configuration-data filter unit
52 Recommendation-candidate generation unit
53 Game-play execution unit
54 Recommendation-information output unit
55 First configuration-data storage unit
56 Reference-information storage unit
57 Second configuration-data storage unit

1. A system that outputs a game medium set to be presented to a player in a game in which game medium sets each constituted of a plurality of game media are used, wherein the system:
generates candidate game medium sets for clearing one unit game by replacing, with other game media, some game media in game medium sets with which the one unit game has been cleared, the game medium sets being included in game logs; and
executes game plays of the one unit game by using the candidate game medium sets for clearing the one unit game and outputs a game medium set with which the one unit game has been cleared.

2. The system according to claim 1, wherein outputting game medium sets with which the one unit game has been cleared includes:
executing the game by using a player terminal or a virtual instance generated for virtualizing a software environment of a player terminal, executing game plays of the one unit game by using the candidate game medium sets for clearing the one unit game, and outputting a game medium set with which the one unit game has been cleared.

3. The system according to claim 1, wherein outputting game medium sets with which the one unit game has been cleared includes:
storing candidate game medium sets with which the one unit game has been cleared as cleared game medium sets of the one unit game; and
outputting at least one game medium set among the cleared game medium sets of the one unit game.

4. The system according to claim 3, wherein outputting at least one game medium set among the cleared game medium sets of the one unit game includes outputting at least one game medium set among a plurality of stored cleared game medium sets of the one unit game on the basis of game media possessed by the player.

5. The system according to claim 1, wherein generating candidate game medium sets includes generating candidate game medium sets by individually replacing one or more game media having high in-game values, the game media constituting parts of game medium sets with which one unit game has been cleared, the game medium sets being included in game logs, with one or more game media having high preset priority levels or priority ranks.

6. The system according to claim 1, wherein generating candidate game medium sets includes generating candidate game medium sets by individually replacing one or more game media having high in-game values with one or more other game media, the game media constituting parts of game medium sets with which one unit game has been cleared, the game medium sets being included in game logs, and the one or more other game media are game media having high preset priority levels or priority ranks and having high compatibility individually with the one or more game media that are replaced.

7. The system according to claim 6, wherein the one or more game media having high in-game values, the game media constituting parts of game medium sets with which one unit game has been cleared, the game medium sets being included in game logs, are game media having high rarities or game media having low rates of possession by players among the game medium sets.

8. The system according to claim 1, wherein generating candidate game medium sets includes acquiring, for each subject unit game, game medium sets with which the unit game has been cleared from a game server storing game logs generated through actual game plays by players.

9. The system according to claim 1, wherein:
each game medium has a level set therefor; and
when game plays of one unit game are executed by using candidate game medium sets for clearing the one unit game, the individual game media included in the candidate game medium sets are set to a preset level corresponding to the one unit game.

10. The system according to claim 1, wherein when the game is executed by using a virtual instance, the game is executed in the virtual instance in a headless mode or with a GPU and a sound device virtualized so that at least graphic processing and sound processing are substantially disabled.

11. The system according to claim 1, wherein generating candidate game medium sets is generating candidate game medium sets for clearing one unit game by replacing, with other game media, some game media in game medium sets with which the one unit game has been cleared with a certain grade or higher or while satisfying a condition, the game medium sets being included in game logs.

12. A method of outputting a game medium set to be presented to a player in a game in which game medium sets each constituted of a plurality of game media are used, wherein:
candidate game medium sets for clearing one unit game are generated by replacing, with other game media, some game media in game medium sets with which the one unit game has been cleared, the game medium sets being included in game logs; and
game plays of the one unit game are executed by using the candidate game medium sets for clearing the one unit game, and a game medium set with which the one unit game has been cleared is output.

13. The method according to claim 12, wherein outputting game medium sets with which the one unit game has been cleared includes:
executing the game by using a player terminal or a virtual instance generated for virtualizing a software environment of a player terminal, executing game plays of the one unit game by using the candidate game medium sets for clearing the one unit game, and outputting a game medium set with which the one unit game has been cleared.

14. The method according to claim 12, wherein generating candidate game medium sets includes generating candidate game medium sets by individually replacing one or more game media having high in-game values, the game media constituting parts of game medium sets with which one unit game has been cleared, the game medium sets being included in game logs, with one or more game media having high preset priority levels or priority ranks.

15. The method according to claim 12, wherein generating candidate game medium sets includes generating candidate game medium sets by individually replacing one or more game media having high in-game values with one or more other game media, the game media constituting parts of game medium sets with which one unit game has been cleared, the game medium sets being included in game logs, and the one or more other game media are game media having high preset priority levels or priority ranks and having high compatibility individually with the one or more game media that are replaced.

16. A non-transitory computer readable medium storing a program for causing a computer to execute a method according to claim 12.
